(19) United States
(12) Patent Application Publication
(10) Pub. No.: US 2016/0356889 A1
(43) Pub. Date: Dec. 8, 2016

(54) Laser Measuring System and Method

(71) Applicant: Magenium Solutions LLC, Glen Ellyn, IL (US)

(72) Inventors: Thomas C. LaMantia, Wheaton, IL (US); Timothy Traxinger, Wheaton, IL (US); Eric Reiner, St. Charles, IL (US); Matthew R. Goeringer, Wheaton, IL (US); Mark Miller, Glen Ellyn, IL (US)

(73) Assignee: Magenium Solutions LLC, Glen Ellyn, IL (US)

(21) Appl. No.: 15/173,409

(22) Filed: Jun. 3, 2016

Related U.S. Application Data
(60) Provisional application No. 62/171,419, filed on Jun. 5, 2015.

(51) Int. Cl. G01S 17/42; G01B 11/26

(52) U.S. Cl. CPC G01S 17/42; G01B 11/26

(57) ABSTRACT

The measuring system may include an input unit configured to receive an indication of a desired measurement and a reference point. The measuring system may include a laser unit including one or more lasers, and may be configured to emit laser light and detect laser data. The measuring system may include a measurement control unit connected to the laser unit. The measurement control unit may be configured to adjust the laser unit such that the laser light is deposited onto a location corresponding with the reference point. The measurement control unit may be configured to determine the desired measurement based on the laser data. The measuring system may include an output unit configured to output the determined desired measurement.

### CROSS-REFERENCE TO RELATED APPLICATIONS

This application claims priority to, and benefit of U.S. Provisional Application No. 62/171,419 filed on Jun. 5, 2015, which is hereby incorporated by reference in its entirety for all purposes.

### FIELD

The present disclosure generally relates to a laser measuring system. More particularly, the disclosure includes a system and method of performing measurements using a laser measuring device.

### BACKGROUND

Laser measuring devices may be used to determine distances to objects. Laser measuring devices, such as laser levels, may also be used as a guide for establishing straight, level lines. Furthermore, laser levels may be used when hanging objects from walls or establishing a level surface, such as a floor.

### SUMMARY

A measuring system is disclosed. In various embodiments, the measuring system may include an input unit configured to receive an indication of a desired measurement and a reference point. The measuring system may include a laser unit including one or more lasers, and may be configured to emit laser light and detect laser data. The measuring system may include a measurement control unit connected to the laser unit. The measurement control unit may be configured to adjust the laser unit such that the laser light is deposited onto a location corresponding with the reference point. The measurement control unit may be configured to determine the desired measurement based on the laser data. The measuring system may include an output unit configured to output the determined desired measurement.

In various embodiments, the measuring system may further comprise a camera configured to detect image data, the measurement control unit may be further configured to provide a user interface based on the image data, and the reference point may be indicated on the user interface.

In various embodiments, the input unit may be further configured to receive annotation data, and the measuring system may further comprise a memory configured to store the annotation data, and associate the annotation data with the image data. In various embodiments, the annotation data includes at least one of text data, audio data, video data, image data, location data, or time data. In various embodiments, the user interface includes an icon associated with the annotation data. In various embodiments, the desired measurement is a distance between two objects. In various embodiments, the desired measurement is an angle formed between two adjacent surfaces.

In various embodiments, the measuring system may comprise a measuring device and a user device, and the measuring device may include the laser unit and the user device may include the input unit, the measurement control unit, and the output unit. In various embodiments, the measuring device may be communicatively coupled to the user device via a data communications protocol. In various embodiments, the measuring device may be at least one of a case, cover, or mount for the user device. In various embodiments, the measuring device may receive power from the user device.

A measuring device is also disclosed. The measuring device may include an input unit configured to receive an indication of a desired measurement, and receive an identification of a first location and a second location. The measuring device may include a laser unit including one or more lasers. The laser unit may be configured to emit a first beam of laser light onto the first location, a second beam of laser light onto the second location, and a third beam of laser light onto a third location. The laser unit may be configured to detect laser data including a first distance between the measuring device and the first location, a second distance between the measuring device and the second location, and a third distance between the measuring device and the third location. The measuring device may include a measurement control unit connected to the laser unit and configured to determine the desired measurement based on the laser data. The measuring device may include an output unit configured to output the determined desired measurement.

In various embodiments, the measurement control unit may be further configured to adjust an orientation of the one or more lasers of the laser unit such that the first beam of laser light is emitted onto the first location and the second beam of laser light is emitted onto the second location based on the identification of the first location and the second location received by the input unit.

In various embodiments, the desired measurement may be a distance between the first location and the second location. In various embodiments, the desired measurement is an arc length between the first location and the second location. In various embodiments, the desired measurement is an angle between two adjacent surfaces. In various embodiments, the laser data further includes two or more angles between the first beam of laser light and the second beam of laser light, the first beam of light and the third beam of laser light, or the second beam of light and the third beam of light.

A method of determining a desired measurement is disclosed. In various embodiments, the method may include detecting, by a camera, image data. The method may include providing, by a measurement control unit, a user interface based on the image data. The method may include receiving, by an input unit, the desired measurement on the user interface. The method may include detecting, by a laser unit, laser data. The method may include determining, by the measurement control unit, the desired measurement based on the laser data.

In various embodiments, the laser unit may be configured to emit three beams of laser light, and the laser data may include a first distance associated with a first beam of laser light, a second distance associated with a second beam of laser light, and a third distance associated with a third beam of laser light.

In various embodiments, the method may further include receiving, by the input unit, annotation data; and storing, by a memory, the annotation data, the annotation data associated with the image data. In various embodiments, the annotation data may include the desired measurement.

The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be exemplary in nature and non-limiting.

### BRIEF DESCRIPTION OF THE DRAWINGS

A more complete understanding of the present disclosure may best be obtained by referring to the detailed description and claims when considered in connection with the figures, wherein like numerals denote like elements.

FIG. 1 illustrates a measuring system, in accordance with various embodiments;

FIG. 2 illustrates a block diagram of the measuring system, in accordance with various embodiments;

FIG. 3 illustrates a side view of the measuring system, in accordance with various embodiments;

FIG. 4 illustrates a perspective view of the measuring system, in accordance with various embodiments;

FIGS. 5A, 5B, and 5C illustrate a measuring device, in accordance with various embodiments;

FIGS. 6A and 6B illustrate uses of the measuring system, in accordance with various embodiments; and

FIG. 7 illustrates a flow chart of the operation of the measuring system, in accordance with various embodiments.

### DETAILED DESCRIPTION

The detailed description of exemplary embodiments herein makes reference to the accompanying drawings, which show exemplary embodiments by way of illustration. While these exemplary embodiments are described in sufficient detail to enable those skilled in the art to practice the exemplary embodiments of the disclosure, it should be understood that other embodiments may be realized and that logical changes and adaptations in design and construction may be made in accordance with this disclosure and the teachings herein. Thus, the detailed description herein is presented for purposes of illustration only and not limitation. The steps recited in any of the method or process descriptions may be executed in any order and are not necessarily limited to the order presented. Furthermore, any reference to singular may include plural embodiments, and any reference to more than one component or step may include a singular embodiment or step. It is to be understood that unless specifically stated otherwise, references to “a,” “an,” and/or “the” may include one or more than one and that reference to an item in the singular may also include the item in the plural.

All ranges and ratio limits disclosed herein may be combined. Also, any reference to attached, fixed, connected or the like may include permanent, removable, temporary, partial, full and/or any other possible attachment option. Additionally, any reference to without contact (or similar phrases) may also include reduced contact or minimal contact.

The present disclosure is described in one or more embodiments in the following description with reference to the figures, in which like numerals represent the same or similar elements. While the disclosure is described in terms of the best mode for achieving the disclosure's objectives, it will be appreciated by those skilled in the art that it is intended to cover alternatives, modifications, and equivalents as may be included within the spirit and scope of the disclosure as defined by the appended claims and their equivalents as supported by the following disclosure and drawings.

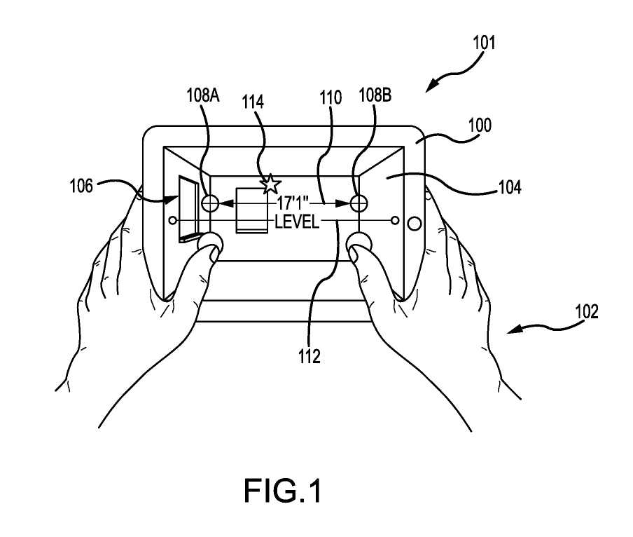

In various embodiments, FIG. 1 illustrates a measuring device 100 used by user 102 for measuring distances and angles. Measuring device may be part of a measuring system 101. Measuring device 100 includes a display 104 displaying a user interface 106. The user interface may be generated and rendered based on image data from a camera of the device 100. The user interface 106 may provide an indication of a distance between objects detected by the image data. FIG. 1 illustrates a user interface 106 that shows a room. The image of the room may be generated based on image data from a camera or other imaging sensor. User interface 106 also indicates a first reference point 108A and a second reference point 108B and a distance 110 between the first reference point 108A and the second reference point 108B. The distance 110 may be determined by one or more lasers, as described herein. User interface 106 also provides an indication of a level line 112. As used herein, “level” refers to establishing a true horizontal alignment.

Display 104 may be a touchscreen display configured to detect touch data by a user, such as user 102. User 102 may communicate an indication of where the first reference point 108A and the second reference point 108B are located on the image, using the touchscreen display. In response to an adjustment of reference points 108, the device 100 may adjust the one or more lasers to determines distance data associated with distance 110 between the reference points 108.

Measuring device 100 may identify corresponding locations in the real world associated with the reference points 108 and adjust the one or more lasers to emit laser light to the corresponding locations in the real world. Upon identifying the locations in the real world associated with the reference points 108, the one or more lasers detect laser data associated with each location in the real world and measuring device 100 determines measurements based on the laser data. The measurements may include radiuses, angles, distance between objects, center of an object, and plumb. Annotations and determined measurements may be inscribed or displayed over an image or video.

In various embodiments, the measuring system 101 also includes an interactive annotation application, which provides the user interface 106. User 102 may annotate an image provided by the user interface 106, using the device 100. Annotations may be identified by an icon 114 on the user interface 106. Annotations may include a written note. For example, the user 102 may annotate the image of the room of FIG. 1 with a written note associated with the window, noting the type of window or a feature of the window. Annotations may include a recorded audio note, such as a voice recording noting the state of the room or the user's 102 initial impression of the room. Annotations may include another image. User 102 may notice a feature such as a hole in the wall or a crack in the window and take a picture closer to the feature and annotate the image of the room with the picture closer to the feature, for later reference. In various embodiments, an image may be annotated with a picture, and the picture may be further annotated with another picture. Annotations may include a checklist, such as a list of things to repair in the room, or a list of measurements of the room. Annotations may include geographical information, such as a slope of the room or building that includes the room, topography of the surrounding area, or direction that was faced when the image was taken (e.g., north, south, north-by-northwest). Annotations may include location information, such as latitude and longitude or city, county, state, and country information. The location information may be provided by a global positioning system (GPS) unit. Annotations may include time information. By associating annotations within an image, processing time may be improved, as fewer files must be traversed in order to locate the appropriate associated annotation.

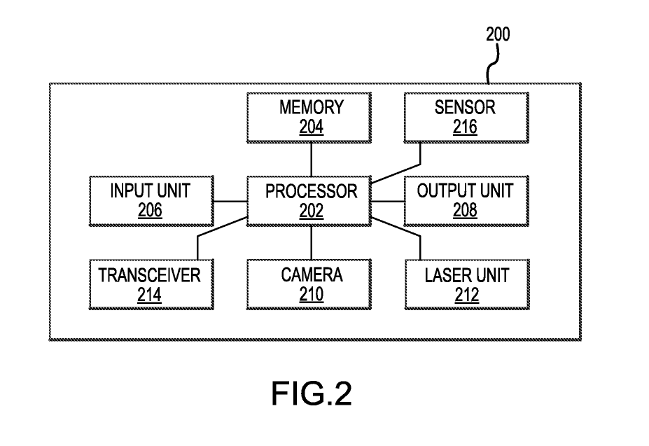

FIG. 2 is a block diagram of measuring device 200. Measuring device 200 may be a user device, such as a tablet computer, smart phone, laptop computer, or any other mobile computing device. In various embodiments, measuring device 200 may include a measurement control unit 202, memory 204, input unit 206, output unit 208, camera 210, laser unit 212, transceiver 214, and sensor 216.

Measuring device 200 may be an attachment such as a mount, case, sleeve, or peripheral device for a separate user device. When the measuring device 200 is used in conjunction with a separate user device, measuring device 200 is communicatively coupled with the user device and the measuring device 200 may include laser unit 212 only, and the remaining elements (memory 204, input unit 206, output unit 208, camera 210, laser unit 212, transceiver 214, and sensor 216) are provided by the separate user device.

Input unit 206 may be coupled to measurement control unit 202 and configured to receive input from a user. Input unit 206 may include a microphone, keypad, keyboard, touchpad, or any other input device. Input unit 206 may operate in conjunction with camera 210 and measurement control unit 202 to interpret gestures made by the user as a method of providing input to measuring device 200. When input unit 206 includes a touchpad, the touchpad may be capable of detecting an indication to zoom in or out, of an image or an annotation, by detecting a gesture of the user, such as moving two fingers on the touchpad away from each other, or toward each other.

Output unit 208 may be coupled to measurement control unit 202 and configured to provide output to the user. Output unit 202 may include a speaker, a vibration unit, a display, or any other output device.

Camera 210 may be coupled to measurement control unit 202 and configured to detect image data. Camera 210 may include one or more cameras, or a distance recognition sensor, such as RADAR or LIDAR, configured to detect spatial data. Camera 210 may be a 180 degree panoramic camera. In various embodiments, an entire room may be represented by four photos, using the panoramic camera.

Laser unit 212 may be coupled to measurement control unit 202 and configured to detect laser data and configured to emit laser light. Laser unit 212 may include one or more lasers. In various embodiments, laser unit 212 is a single laser that produces three beams of laser light. In various embodiments, laser unit 212 includes two or more lasers that produce three beams of laser light. Laser unit 212 may include an actuator configured to adjust orientation of the beams of laser light produced by laser unit 212. Orientation of the beams of laser light may be adjusted by adjusting the source of the laser light (e.g., the respective laser) or may be adjusted by adjusting a prism or mirror located near the laser, such that adjusting the prism or mirror adjusts the direction of the laser light.

Orientation of the beams of laser light may be adjusted simultaneously or individually. Orientation of the laser unit 212 may be adjusted based on instruction from the measurement control unit 202. Measurement control unit 202 may receive, via input unit 206, an indication to adjust orientation of the laser unit 212, and accordingly, measurement control unit 202 may instruct laser unit 212 to adjust orientation. For example, a user may provide a voice instruction detected by input unit 206 that indicates that the laser unit 212 should rotate downwards vertically. Measurement control unit 202, based on the input data detected by input unit 206, instructs laser unit 212 to rotate downwards vertically.

The laser unit 212 may emit beams of light (e.g., three beams), and the three beams of laser light may terminate at three locations. The laser unit 212 determines distances associated with each of the locations. For example, the three beams of laser light may terminate at locations located 12 feet away, 8 feet away, and 13 feet away from the measuring device 200. In various embodiments, the laser unit 212 determines distances associated with each of the locations using time of flight, by determining a time between emitting a laser light beam and detecting when the emitted laser light beam reflects off of the surface. The laser unit 212 may detect when the emitted laser light beam reflects off of the surface using camera 210 or sensor 216. The laser unit 212 detects the laser data (e.g., distances between the measuring device 200 and various locations) and communicates it to the measurement control unit 202, which determines a distance between any two of the locations based on the laser data.

Transceiver 214 may be coupled to measurement control unit 202 and may be a receiver and/or a transmitter configured to receive and transmit data from a remote data storage or other device using a data communications protocol. The transceiver 214 may include an antenna capable of transmitting and receiving wireless communications using the data communications protocol. For example, the antenna may be a Bluetooth or Wi-Fi antenna, a cellular radio antenna, a radio frequency identification (RFID) antenna or reader and/or a near field communication (NFC) unit. When measuring device 200 is an attachment to a user device, measuring device 200 may communicate data to and from the user device via transceiver 214.

Sensor 216 may be coupled to measurement control unit 202. Sensor 216 may include one or more sensors. Sensor 216 may include an inertial measurement unit (IMU) configured to provide orientation data of the measuring device 200. Measuring device 200, using measurement control unit 102 and IMU, may determine and display a level line (e.g., level line 112) on the user interface based on the orientation data. Sensor 216 may include a GPS unit configured to determine location data.

Measurement control unit 202 may be coupled to memory 204, input unit 206, output unit 208, camera 210, laser unit 212, transceiver 214, and sensor 216. Measurement control unit 202 is configured to receive input data from the input unit 206, communicate output data to output unit 208, receive image data from camera 210, receive laser data from laser unit 212, communicate and receive data via transceiver 214, and receive sensor data from sensor 216, such as orientation data or location data. Measurement control unit 202 is configured to provide the interactive annotation application and is configured to determine distances and measurements based on the laser data.

In various embodiments, the measurement control unit 202 provides the interactive annotation application which provides the user interface. The measurement control unit 202 receives image data from camera 210 and displays the image on the user interface. The measurement control unit 202 receives input data from the input unit 206. The input data may include an indication of type of measurement desired, such as an angle measurement or a distance measurement. The input data may also include identification of reference points on the displayed image associated with the desired measurement.

The measurement control unit 202 communicates adjustment data to the laser unit 212 to adjust the orientation of the lasers of laser unit 212. The lasers of laser unit 212 emit beams of laser lights that are deposited on locations of a surface. The lasers detect laser data associated with the laser lights and communicate the laser data to the measurement control unit 202. The measurement control unit 202 determines measurements based on the laser data, such as an angle between two surfaces, a straight distance between two reference points, or a curved distance between two reference points.

In various embodiments, determining the measurement by the measurement control unit 202 is triggered by an input from the input unit 206, such as an a voice command or a button press or tap. The lasers of laser unit 212 may continuously detect laser data, but a distance between two reference points may not be determined until the measurement determination is triggered.

The measurement control unit 202 also receives annotation data associated with the displayed image. Annotation data may include text, audio data, video data, image data, location data, or geographical data. The annotation data may be stored in memory 204.

In various embodiments, the measurement control unit 202 is a specialized device for determining measurements based on laser data and managing annotations. In various embodiments, the measurement control unit 202 performs determinations at a faster rate than is capable by a human being, and at a finer level of granularity.

Memory 204 may be a local memory unit or may be a remote database. When memory 204 is a remote database, the transceiver 214 is used to access the memory 204. Remote databases may include databases storing local building codes, national building codes, materials, standards, vendors, legislative guidelines (e.g., OSHA guidelines), and other regulatory guidelines. Memory 204 may store previously measured distances between reference points and between locations. Memory 204 may also store annotations associated with images. Memory 204 may also include software packages particular to a trade or need, such as architectural software or interior design software. The software packages may include the production of forms or computer aided drafting files. Memory 204 may also store reminders for the user to obtain particular measurements. The reminders may be triggered based on geographic location, as detected by sensor 216.

Memory 204 may store code for the measurement device and interactive annotation application, and the code may include any suitable programming language, such as Unity, C++, Visual Basic, or other computer coding language in any dialect such as English, Spanish, or other language or dialect. Alternatively, code may be stored on external media, such as flash memory, DVD, CD, Blu-Ray, or other suitable electronic storage medium. In one example, measurement control unit 202 may include built-in hardware and software built on Windows 8 technology with a Unity software engine.

Measurement control unit 202 may include one or more processors and one or more tangible, non-transitory memories and be capable of implementing logic. The processor can be a general purpose processor, a digital signal processor (DSP), an application specific integrated circuit (ASIC), a field programmable gate array (FPGA) or other programmable logic device, discrete gate or transistor logic, discrete hardware components, or a combination thereof.

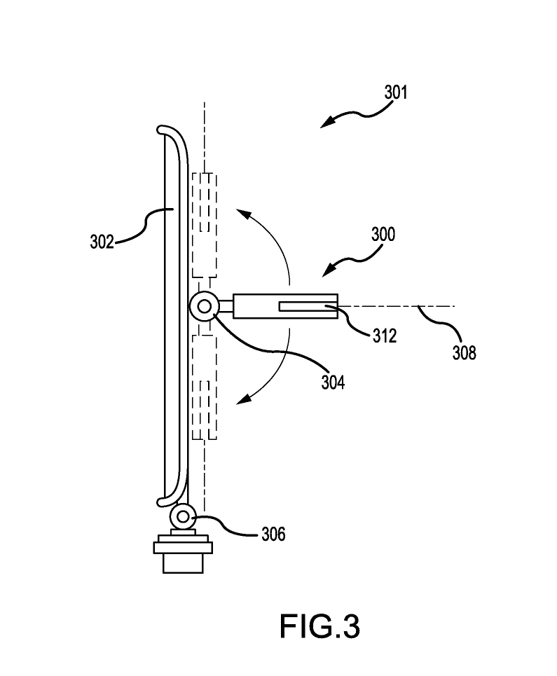

FIG. 3 illustrates a measuring system 301. In various embodiments, the measuring system 301 includes a measuring device 300 and a user device 302. In various embodiments, the measuring device 300 and the user device 302 are integrated into a single device of the measuring system 301. In various embodiments, the measuring device 300 and the user device 302 are separate.

Measuring device 300 may include a user device dock 304 configured to couple the measuring device 300 to the user device 302. In various embodiments, the user device dock 304 is configured to provide a communicative coupling between the measuring device 300 and the user device 302. The communicative coupling may be via a USB connection, or a serial data connection. In various embodiments, the user device dock 304 physically couples the measuring device 300 and the user device 302, and the measuring device 300 and the user device 302 receive and transmit data via a wireless connection, such as Bluetooth, Wi-Fi, NFC, or the like.

User device dock 304 may also include base mount 306 configured to couple the measuring device 300 to a base, such as a tripod, such that measuring device 300 remains stationary without being held by a user.

Measuring device 300 includes a laser unit 312 which is configured to emit one or more beams of laser light 308. Measuring device 300 is also configured to be adjusted or rotated, as shown by the arrows in FIG. 3. Measuring device 300 may be oriented in a normal position such that the laser light 308 is emitted in a direction perpendicular to a display of user device 302. Measuring device 300 may be rotated vertically in a positive or negative direction to achieve any position between +90° and −90° relative to the normal position. Orientation of measuring device 300 may be adjusted by the user physically manipulating the measuring device 300, or by the user providing an indication to the user device 302 to adjust the orientation of measuring device 300. Measuring device 300 may be connected to the user device dock 304 at an inline or socket joint, such that the measuring device 300 may achieve a full range of motion.

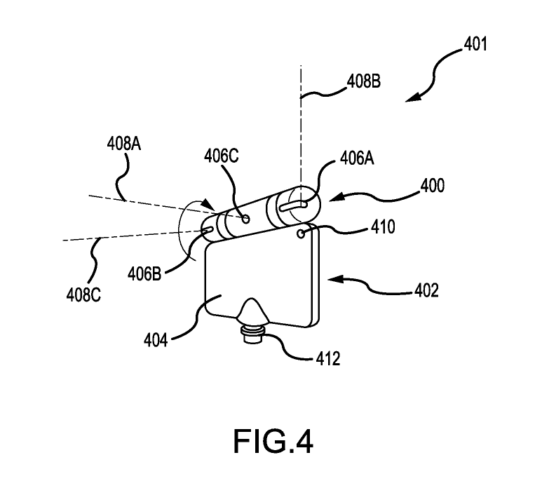

FIG. 4 illustrates a measuring system 401. In various embodiments, the measuring system 401 includes a measuring device 400 and a separate user device 402. In various embodiments, the measuring device 400 and the user device 402 are integrated into a single device of the measuring system 401.

Measuring device 400 may be attached to a user device dock 404 configured to couple the measuring device 400 to the user device 402. In various embodiments, the user device dock 404 is configured to provide a communicative coupling between the measuring device 400 and the user device 402, as described herein. In various embodiments, the device dock 404 physically couples the measuring device 400 and the user device 402. User device dock 404 may also include a base mount 412 configured to couple the user device dock 404 to a base, such as a tripod. In various embodiments, user device dock 404 facilitates providing of power to the measuring device 400 from the user device 402. User device 402 may provide power to measuring device 400 via an electronic connection, such as USB. In various embodiments, measuring device 400 includes a power supply, such as a battery, such that measuring device 400 may not be powered by user device 402.

Measuring device 400 includes three lasers 406A, 406B, 406C, which emit laser lights 408A, 408B and 408C, respectively. Measuring device 400 may be adjusted or rotated, vertically and/or horizontally. In various embodiments, when measuring device 400 rotates vertically, lasers 406 rotate vertically simultaneously. In various embodiments, each of the three lasers 406A, 406B, 406C may be rotated vertically independently. In various embodiments, lasers 406 are capable of vertical rotation in 360 degrees, either simultaneously or independently. In various embodiments, a center laser 406C remains stationary with respect to horizontal movement, and side lasers 406A and 406B are each capable of adjustment horizontally, up to 180 degrees. In various embodiments, the side lasers 406A and 406B are adjusted simultaneously, such that an angle formed between laser light 408A and 408C is the same as an angle formed between laser light 408B and 408C. In various embodiments, the side lasers 406A and 406B are adjusted independently, such that the angle formed between laser light 408A and 408C may not be the same as the angle formed between laser light 408B and 408C. As described herein, lasers 406 may be adjusted by a user providing an indication to user device 402 to adjust orientation of lasers 406 via a user interface (e.g., user interface 106).

In various embodiments, laser lights 408 are coplanar, such that an angle formed between laser lights 408A and 408B comprises an angle between 408A and 408C and an angle between 408B and 408C. In various embodiments, laser lights 408 are not coplanar, and distinct angles may be formed between laser lights 408A and 408B, laser lights 408B and 408C, and laser lights 408A and 408C.

In various embodiments, the measuring system 401 may include features using various hardware, software and/or any combination thereof. For example, communications between the measuring device 400 and the user device 402 may be accomplished via serial communications (e.g., over Bluetooth, USB, and/or direct serial communication). Communication may be initiated by the user device 402 which sends a 2-3 character code with an optional parameter terminated by a carriage return. The response may be a stream of data terminated by the string “END” and a carriage return.

In various embodiments, the following table details exemplary commands that the measuring device 400 may support and the potential responses from the commands:

| Command | | |
|---|---|---|
| Code | Definition | Response |
| MA | Measure | 3 measurement values, 1 from each |
| | | laser |
| ML | Measure left | 1 measurement value from the left |
| | | laser |
| MC | Measure center | 1 measurement value from the center |
| | | laser |
| MR | Measure right | 1 measurement value from the right |
| | | laser |
| MC | Measure Continue | Repeated measurements from the 3 |
| | | lasers (same as M but repeating). |
| MS | Measure Stop | Stops the repeating reading |
| RS | Reset | Resets the device to is standard |
| | | settings |
| AD | Adjust cameras and | Status message (OK, ERR) |
| | laser for lighting | |
| | conditions | |
| CL | Calibrate the system | Status message (OK, ERR) |
| CCL | Capture a color image | Color image data from the left |
| | | laser/camera |
| CBL | Capture a black and | Black and white image data left |
| | white image | laser/camera |
| CCC | Capture a color image | Color image data from the center |
| | | laser/camera |
| CBC | Capture a black and | Black and white image data center |
| | white image | laser/camera |
| CCR | Capture a color image | Color image data from the right |
| | | laser/camera |
| CBR | Capture a black and | Black and white image data right |
| | white image | laser/camera |
| SA # | Set angle for left/right | Status message (OK, ERR) |
| | lasers. | |
| VR | Version request | Version string of the embedded |
| | | software |
| LO | Location request | Returns the latitude and longitude of |
| | | the device |
| AL | Accelerometer value | Returns all 3 accelerometer values for |
| | | x, y and z |
| XL | X Axis Accelerometer | Returns the value for the X axis |
| | value | |
| YL | Y Axis Accelerometer | Returns the value for the Y axis |
| | value | |
| ZL | Z Axis Accelerometer | Returns the value for the Z axis |
| | value | |
| BL | Battery Level | Estimated percentage of battery life |
| | | left |
| PS | Power Save | Disable all components other than |
| | | communications |
| PR | Power Resume | Enable all components for use (return |
| | | from Power Save mode) |
| GR | Gyroscope value | Returns the rate of rotation on all 3 |
| | | axis as 3 values |
| BP | Emit a beep sound | Status Message (OK, ERR) |
| BK | Blink light 1 time (a | Status Message (OK, ERR) |
| | single flash) | |

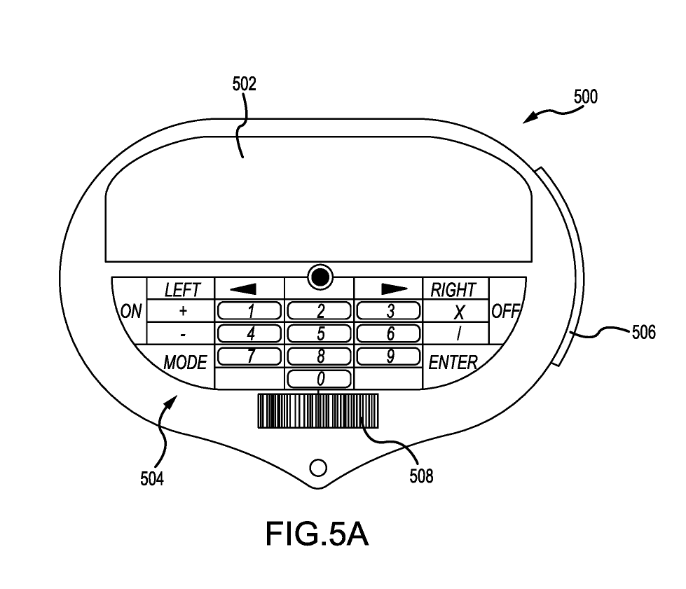

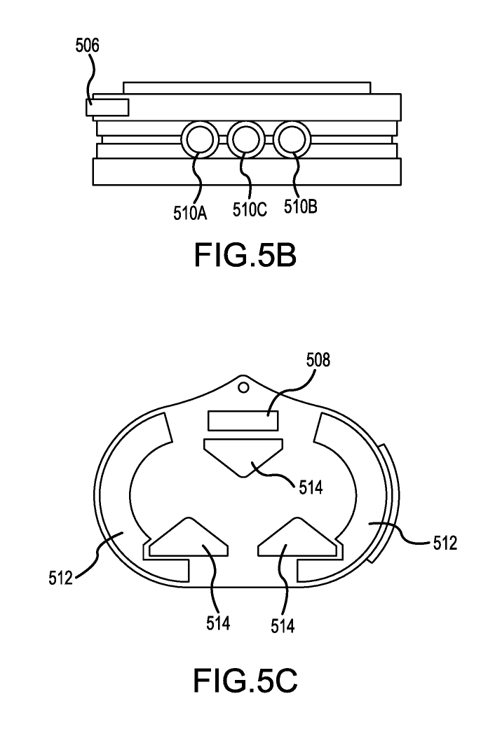

FIGS. 5A, 5B, and 5C illustrate a measuring device 500. Measuring device 500 includes a display 502, keypad 504, capture button 506, thumb wheel 508, lasers 510, magnets 512, and feet 514. Measuring device 500 may be communicatively coupled to a user device (e.g., user devices 302 and 402). Measuring device 500 is configured to determine distances and measurements, such as an angle between two adjacent walls of a room, a distance between two locations, a radius of a structural arc, or whether the device 500 is located at a midpoint between two locations.

Display 502 is configured to display measured distances or angles. Display 502 is also configured to display indications, such as whether a target measurement is met, or whether the device 500 is located at a midpoint between two reference points.

Keypad 504 is configured to receive user input. User input may include adjustment of operating mode of the measuring device 500. For example, whether an angle is being measured or distance is being measured may be toggled. User input may include adjustment of orientation of the lasers 510, as described herein. For example, if the user would like to adjust side laser 510A and/or 510B, the user may use the keypad 504. User input may include a target measurement, and measuring device 500 may provide an indication using display 502 when the target measurement is achieved. For example, the target measurement may be 15 feet, and display 502 may indicate when the laser light beams emitted by the side lasers onto a surface are 15 feet apart.

Capture button 506 is configured to receive a measurement capture trigger to determine a measurement. For example, the lasers 510 may continuously detect laser data, but a distance between two reference points corresponding to two of the lasers 510 may not be determined until the measurement capture trigger is provided via capture button 506.

Thumb wheel 508 is configured to adjust orientation of lasers 510. A user may turn thumb wheel 508 and thereby adjust the angle formed between side lasers 510A, 510B and center laser 510C. In various embodiments, center laser 510C remains fixed relative to the measuring device 500 and orientation of side lasers 510A and 510B may be adjusted. In various embodiments, the orientation of side lasers 510A and 510B are adjusted simultaneously such that the angle between side laser 510A and center laser 510C is the same as the angle between side laser 510B and center laser 510C. In various embodiments, the orientation of side lasers 510A and 510B are adjusted individually, such that the angle between side laser 510A and center laser 510C may not be the same as the angle between side laser 510B and center laser 510C.

Lasers 510 are lasers configured to each emit a beam of laser light and detect laser data. The laser data detected by each of the lasers 510 is associated with the distance between the device 500 and a location on a surface where the particular laser's laser light is deposited. For example, side lasers 510A and 510B may emit first and second laser lights that are deposited on first and second locations on a surface and center laser 510C may emit a third laser light that is deposited on a third location on the surface. The lasers 510 are configured to detect a first distance between the device 500 and the first location, a second distance between the device 500 and the second location, and a third distance between the device 500 and the third location. The first distance, second distance, and the third distance may collectively be referred to as laser data. Further, the laser data may include angles between the beams of laser light emitted by the side lasers 510A and 510B and center laser 510C. As described herein, device 500 may determine distances and angles based on the laser data.

Magnets 512 allow the measuring device 500 to attach magnetically to a surface. Attaching to a surface may provide stability to the measuring device 500. Alternatively or in addition to the magnets 512, a suction cup may be located on the exterior of measuring device 500 for attaching the measuring device 500 to a surface. Feet 514 are configured to allow the measuring device 500 to be elevated and the feet 514 form a base resembling a tripod.

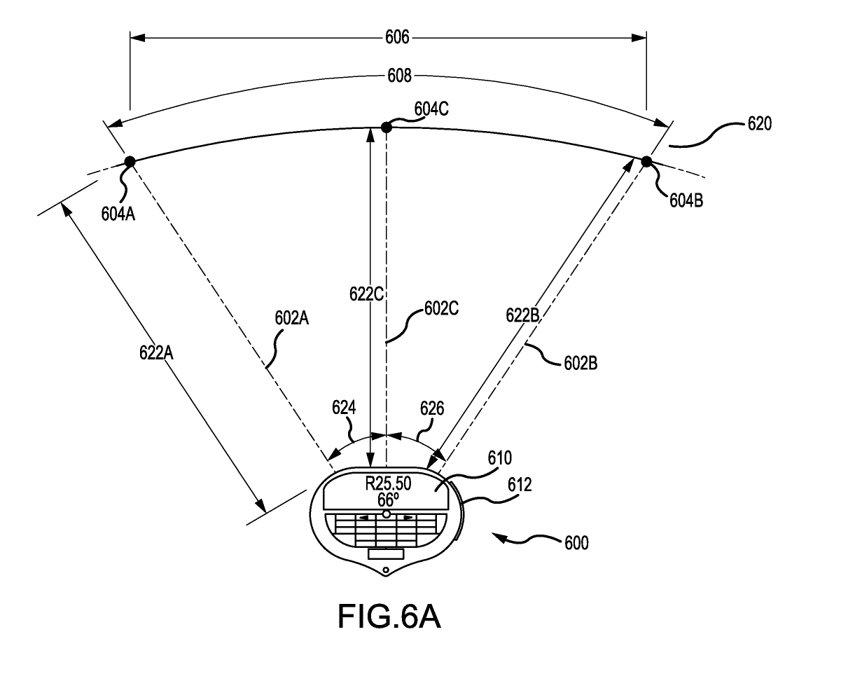

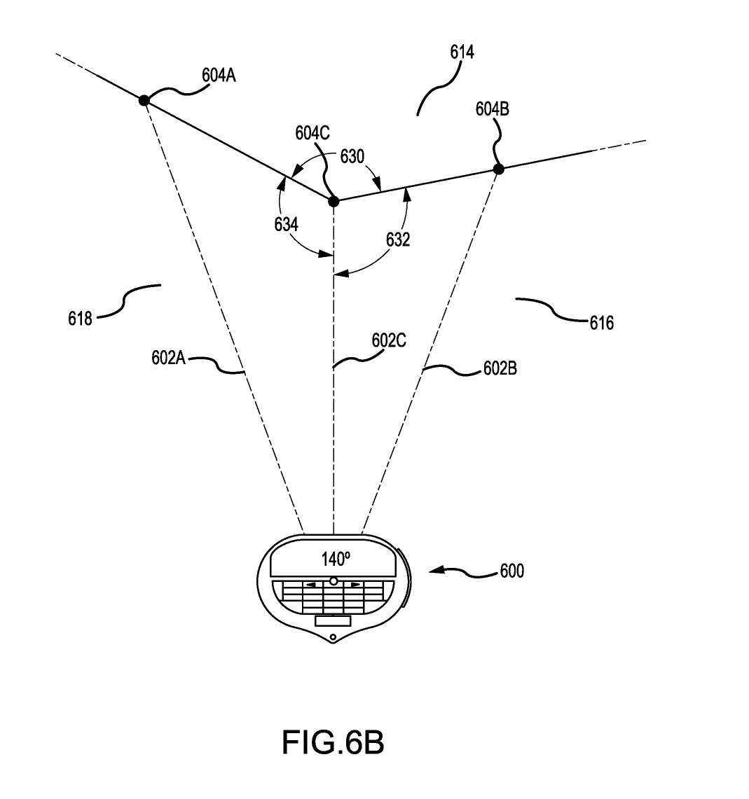

FIGS. 6A and 6B illustrate exemplary uses of measuring device 600, which is similar to measuring devices 100, 200, 300, 400, and 500. Measuring device 600 includes lasers (e.g., lasers 510) configured to emit laser lights 602A, 602B, and 602C, deposited on a surface at locations 604A, 604B, and 604C, respectively. Laser light 602C is a center laser light, and laser lights 602A and 602B are side laser lights. Angle 624 is an angle between laser light 602A and 602C, and angle 626 is an angle between laser light 602B and 602C.

In FIG. 6A, laser lights 602 are emitted and deposited onto an arched surface 620. In operation, the laser lights 602 may continuously be emitted and laser data may be continuously detected. As described herein, laser data includes distance between the measuring device 600 and the location 604. As shown in FIG. 6A, the laser data includes distances 622A, 622B, and 622C. First distance 622A corresponds to a distance between the measuring device 600 and first location 604A corresponding to a first laser light 602A emitted from a first laser. Second distance 622B corresponds to a distance between the measuring device 600 and second location 604B corresponding to a second laser light 602B emitted from a second laser. Third distance 622C corresponds to a distance between the measuring device 600 and third location 604C corresponding to a third laser light 602C emitted from a third laser.

In various embodiments, laser data is captured when capture button 612 is pressed. Laser data may be stored in memory (e.g., memory 204). A measurement control unit of measuring device 600 (e.g., measurement control unit 202) may determine one or more distances based on the laser data. The measurement control unit may determine a distance 606 between locations 604A and 604B corresponding to the side lasers. The measurement control unit may also determine an arc length 608 traversing locations 604A, 604C, and 604B. A combination of distances 622A, 622B, 622C, and/or angles 624, 626 may be used in determining distance 606 and/or arc length 608. Whether distance 606 or arc length 608 is measured may be determined based on user input establishing an operation mode of measuring device 600.

Once the measurement control unit determines distance 606 or arc length 608, the distance 606 or arc length 608 may be displayed on display 610. Any of distances 622A, 622B, 622C, and/or angles 624, 626 may also be displayed on display 610.

In FIG. 6B, laser lights 602 are emitted and deposited onto a corner of a room. The room contains a first wall 616, a second wall 618, and ceiling 614. Laser lights 602 are emitted and deposited onto locations 604 in the room. Location 604A is at an intersection between the second wall 618 and ceiling 614. Location 604B is at an intersection between the first wall 616 and ceiling 614. Location 604C is at the intersection between the first wall 616, the second wall 618, and ceiling 614. In various embodiments, the user of measuring device 600 may hold the measuring device 600 and direct the laser lights 602 onto their respective locations 604. The user may be instructed to direct the laser lights 602 in a particular manner by directions displayed on display 610.

Measuring device 600 may be configured to determine angles 630, 632, 634 between the first wall 616 second wall 618 and ceiling 614. Angle 630 refers to the angle between the first wall 616 and second wall 618, angle 632 refers to the angle between the second wall 618 and ceiling 614, and angle 634 refers to the angle between the first wall 616 and ceiling 614. Measuring device 600 may determine angles 630, 632, and 634 based on laser data detected by lasers of measuring device 600.

Any of the measuring devices described herein (e.g., measuring device 100, 200, 300, 400, 500, or 600), perform measurements to a degree of accuracy that was previously not possible by human beings.

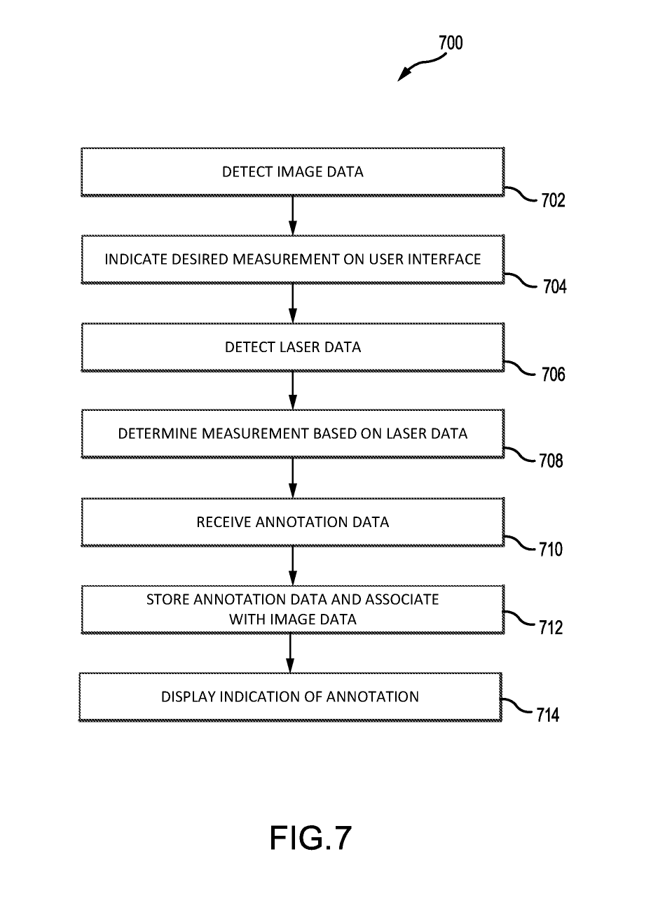

FIG. 7 illustrates a flowchart of a process 700 for determining measurements using the measuring system described herein. While measuring device 200 is used as an exemplary measuring device 200, any of the measuring devices described herein may be used in process 700.

Measuring device 200 may detect image data using camera 210 (step 702). Output unit 208 may include a display, and a user interface may be provided by the measurement control unit 202. The user interface may include an image based on the image data, and the user interface may be displayed by the display.

The user may indicate on the user interface a desired measurement (step 704). For example, the user may indicate a type of measurement, such as a distance between two reference points or an angle between two adjacent surfaces. The user may indicate the reference points used in performing the measurement by providing an indication to the measuring device 200 via the input unit 206. For example, if the user would like to know the distance between a window and a door, as shown on the user interface, the user may indicate a first reference point at the edge of the window and the user may indicate a second reference point at the edge of the door. In some embodiments, the measurement control unit 202 is configured to detect reference points, such as objects or corners, and may automatically adjust the user's indicated reference point to the detected reference point.

Laser unit 212, which includes three lasers (e.g., lasers 406A, 406B, and 406C), emits a first laser light, a second laser light, and a third laser light (e.g., laser lights 408A, 408B, and 408C). The laser lights are deposited on a first location, a second location, and a third location of a surface, and laser data is detected by the laser unit 212 (step 706). For example, the first location may be straight ahead, onto a wall, the second location may be at the edge of the window, as indicated by the first reference point, and the third location may be at the edge of the door, as indicated by the second reference point. Laser data includes a first distance between the measuring device 200 and the first location, a second distance between the measuring device 200 and the second location, and a third distance between the measuring device 200 and the third location. The laser data may also include an angle between the laser lights. For example, the measuring device 200 may be 5 feet away from the wall straight ahead, 12 feet away from the edge of the window, 13 feet away from the edge of the door, the angle between the first laser light and the second laser light may be 30 degrees, and the angle between the first laser light and the third laser light may be 32 degrees.

The laser unit 212 communicates the laser data to the measurement control unit 202. The measurement control unit 202 determines a measurement based on the laser data (step 708). The measurement determined by the measurement control unit 202 may be a distance between any two of the locations (first location, second location, third location), an angle between adjacent surfaces, such as an angle between a wall and a ceiling or two walls, or a length of an arc. In the example embodiment, the measurement control unit 202 determines the distance between the second location and the third location (associated with the first reference point and second reference point, respectively) is 20 feet.

The measurement control unit 202 may instruct the output unit 208 to output the measurement. The output unit 208 may include a display and outputting the measurement may include displaying the measurement. The output unit 208 may include a speaker and outputting the measurement may include speaking the measurement audibly.

A user of the measurement device may indicate, using input unit 206, an adjustment to a desired measurement and the lasers may be adjusted and updated laser data may be detected and used to determine an updated measurement.

The measurement control unit 202 receives annotation data from the user via the input unit 206 (step 710). For example, the input unit 206 may include a keyboard and the annotation data may include written notes. The annotation data may be stored in memory 204 and associated with the image data detected by camera 210 (step 712). The user interface may display an icon associated with the annotation, such that a user may press or click on the icon and the annotation may be presented (step 714). For example, a user may save the measurement of the distance between the door and the window as an annotation. The user, at a later time, may press or click on the icon representing the annotation, and the distance between the door and the window may be presented.

The system may communicate with a smartphone, the internet and/or social networking websites. Any communication, transmission and/or channel discussed herein may include any system or method for delivering content (e.g. data, information, metadata, etc), and/or the content itself. The content may be presented in any form or medium, and in various embodiments, the content may be delivered electronically and/or capable of being presented electronically. For example, a channel may comprise a website or device (e.g., Facebook, YOUTUBE®, APPLE®TV®, PANDORA®, XBOX®, SONY® PLAYSTATION®), a uniform resource locator (“URL”), a document (e.g., a MICROSOFT® Word® document, a MICROSOFT® Excel® document, an ADOBE®.pdf document, etc.), an “ebook,” an “emagazine,” an application or microapplication (as described herein), an SMS or other type of text message, an email, facebook, twitter, MMS and/or other type of communication technology. In various embodiments, a channel may be hosted or provided by a data partner. In various embodiments, the distribution channel may comprise at least one of a merchant website, a social media website, affiliate or partner websites, an external vendor, a mobile device communication, social media network and/or location based service. Distribution channels may include at least one of a merchant website, a social media site, affiliate or partner websites, an external vendor, and a mobile device communication. Examples of social media sites include FACEBOOK®, FOURSQUARE®, TWITTER®, MYSPACE®, LINKEDIN®, and the like. Examples of affiliate or partner websites include AMERICAN EXPRESS®, GROUPON®, LIVINGSOCIAL®, and the like. Moreover, examples of mobile device communications include texting, email, and mobile applications for smartphones.

In various embodiments, components, modules, and/or engines of the system may be implemented as micro-applications or micro-apps. Micro-apps are typically deployed in the context of a mobile operating system, including for example, a WINDOWS® mobile operating system, an ANDROID® Operating System, APPLE® IOS®, a BLACKBERRY® operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

The system may communicate with any network using any data communications protocol. As used herein, the term “network” includes any cloud, cloud computing system or electronic communications system or method which incorporates hardware and/or software components. Communication among the parties may be accomplished through any suitable communication channels using any communications protocol, such as, for example, a telephone network, an extranet, an intranet, Internet, point of interaction device (point of sale device, personal digital assistant (e.g., IPHONE®, BLACKBERRY®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, APPLE®talk, IP-6, NetBIOS®, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA® 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing at http://csrc.nist.gov/publications/nistpubs/800-145/SP800-145.pdf (last visited June 2012), which is hereby incorporated by reference in its entirety.

The computers discussed herein may provide a suitable website or other Internet-based graphical user interface which is accessible by users. In one embodiment, the MICROSOFT® INTERNET INFORMATION SERVICES® (IIS), MICROSOFT® Transaction Server (MTS), and MICROSOFT® SQL Server, are used in conjunction with the MICROSOFT® operating system, MICROSOFT® NT web server software, a MICROSOFT® SQL Server database system, and a MICROSOFT® Commerce Server. Additionally, components such as Access or MICROSOFT® SQL Server, ORACLE®, Sybase, Informix MySQL, Interbase, etc., may be used to provide an Active Data Object (ADO) compliant database management system. In one embodiment, the Apache web server is used in conjunction with a Linux operating system, a MySQL database, and the Perl, PHP, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, JAVA® APPLE®ts, JAVASCRIPT, active server pages XML), helper applications, plug-ins, and the like. A server may include a web service that receives a request from a web server, the request including a URL and an IP address (123.56.789.234). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. See, e.g., ALEX NGHIEM, IT WEB SERVICES: A ROADMAP FOR THE ENTERPRISE (2003), hereby incorporated by reference.

The system may also create, maintain and/or supplement a user profile. A “user profile” or “user profile data” may comprise any information or data about a consumer that describes an attribute associated with the consumer (e.g., a preference, an interest, demographic information, personally identifying information, and the like).

Benefits and other advantages have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, and any elements that may cause any benefit or advantage to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Systems, methods and apparatus are provided herein. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

System program instructions and/or controller instructions may be loaded onto a tangible, non-transitory, computer-readable medium (also referred to herein as a tangible, non-transitory, memory) having instructions stored thereon that, in response to execution by a controller, cause the controller to perform various operations. The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. §101.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f), unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A measuring system comprising:
an input unit configured to receive an indication of a desired measurement and a reference point;
a laser unit including one or more lasers, and configured to emit laser light and detect laser data;
a measurement control unit connected to the laser unit and configured to:
adjust the laser unit such that the laser light is deposited onto a location corresponding with the reference point, and
determine the desired measurement based on the laser data; and
an output unit configured to output the determined desired measurement.

2. The measuring system of claim 1, wherein the measuring system further comprises:
a camera configured to detect image data,
wherein the measurement control unit is further configured to provide a user interface based on the image data, and
wherein the reference point is indicated on the user interface.

3. The measuring system of claim 2, wherein:
the input unit is further configured to receive annotation data, and
the measuring system further comprises a memory configured to store the annotation data, and associate the annotation data with the image data.

4. The measuring system of claim 3, wherein the annotation data includes at least one of text data, audio data, video data, image data, location data, or time data.

5. The measuring system of claim 3, wherein the user interface includes an icon associated with the annotation data.

6. The measuring system of claim 1, wherein the desired measurement is a distance between two objects.

7. The measuring system of claim 1, wherein the desired measurement is an angle formed between two adjacent surfaces.

8. The measuring system of claim 1, wherein:
the measuring system comprises a measuring device and a user device,
the measuring device includes the laser unit, and
the user device includes the input unit, the measurement control unit, and the output unit.

8. The measuring system of claim 8, wherein the measuring device is communicatively coupled to the user device via a data communications protocol.

9. The measuring system of claim 8, wherein the measuring device is at least one of a case, cover, or mount for the user device.

10. The measuring system of claim 8, wherein the measuring device receives power from the user device.

11. A measuring device comprising:
an input unit configured to receive an indication of a desired measurement, and receive an identification of a first location and a second location;
a laser unit including one or more lasers, the laser unit configured to:
emit a first beam of laser light onto the first location, a second beam of laser light onto the second location, and a third beam of laser light onto a third location, and
detect laser data including a first distance between the measuring device and the first location, a second distance between the measuring device and the second location, and a third distance between the measuring device and the third location;
a measurement control unit connected to the laser unit and configured to determine the desired measurement based on the laser data; and
an output unit configured to output the determined desired measurement.

12. The measuring device of claim 11, wherein the measurement control unit is further configured to adjust an orientation of the one or more lasers of the laser unit such that the first beam of laser light is emitted onto the first location and the second beam of laser light is emitted onto the second location based on the identification of the first location and the second location received by the input unit.

13. The measuring device of claim 11, wherein the desired measurement is a distance between the first location and the second location.

14. The measuring device of claim 11, wherein the desired measurement is an arc length between the first location and the second location.

15. The measuring device of claim 11, wherein the desired measurement is an angle between two adjacent surfaces.

16. The measuring device of claim 15, wherein the laser data further includes two or more angles between the first beam of laser light and the second beam of laser light, the first beam of light and the third beam of laser light, or the second beam of light and the third beam of light.

17. A method of determining a desired measurement, the method comprising:
detecting, by a camera, image data;
providing, by a measurement control unit, a user interface based on the image data;
receiving, by an input unit, the desired measurement on the user interface;
detecting, by a laser unit, laser data; and
determining, by the measurement control unit, the desired measurement based on the laser data.

18. The method of claim 17, wherein:
the laser unit is configured to emit three beams of laser light, and
the laser data includes a first distance associated with a first beam of laser light, a second distance associated with a second beam of laser light, and a third distance associated with a third beam of laser light.

19. The method of claim 17, further comprising:
receiving, by the input unit, annotation data; and
storing, by a memory, the annotation data, the annotation data associated with the image data.

20. The method of claim 19, wherein the annotation data includes the desired measurement.
